(19) United States
(12) Patent Application Publication
(10) Pub. No.: US 2008/0008160 A1
(43) Pub. Date: Jan. 10, 2008

(54) Bandwidth management for internet telephony

(76) Inventor: Stephen A. Uhler, Los Altos, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(21) Appl. No.: 11/482,592

(22) Filed: Jul. 6, 2006

(51) Int. Cl. H04L 12/26; H04L 12/66; H04L 12/56; H04J 3/22

(52) U.S. Cl. 370/352; 370/229; 370/468; 370/395.2

(57) ABSTRACT

A system and method to manage Internet telephony bandwidth including a network switch to collect network information, and a telephone switch coupled with a network switch to dynamically allocate bandwidth of an Internet telephone based on network information received from a network switch are described herein.

### FIELD

Embodiments of the invention relate to Internet telephony. In particular, embodiments of the invention relate to bandwidth management for Internet telephony.

### BACKGROUND

Internet telephony or Voice over Internet Protocol (VoIP) uses a packet-switched network, such as the Internet, to transport voice conversations as an alternative to the dedicated Public Switched Telecommunications Network (PSTN). The use of the Internet to transport voice offers to provide a wider range of features and reduce infrastructure costs by only needing one network for both data and voice. Unlike data, voice conversations are sensitive to delay, jitter, and lost packets, which are common in packet-switched networks designed to optimize the amount of data passed through the network and not designed to move data quickly through the network. Because of the sensitivity of voice conversations to delay, jitter, and lost packets, the packet-switched networks that carry the voice conversations are designed to ensure a quality of service (QoS) for the voice conversations over the network.

To achieve a quality of service for voice conversations over a packet-switched network, some networks are designed to minimize the likelihood of delay, jitter, and lost packets through balancing the bandwidth for data versus the bandwidth for voice. Because the amount of bandwidth a network carries at any one time is difficult to predict, networks may be over engineered by setting aside more bandwidth than is necessary to ensure a quality of service for Internet telephony on the network. Over-engineering a network may add to the cost of the network and under utilization of the all the bandwidth the network can provide. One example of over-engineering a network includes setting aside an amount of bandwidth dedicated to just voice conversations.

Another method to minimize delay in a packet-switched network is to prioritize packets to try to maintain a quality of service. Under this method certain packets, such as those including voice conversations, are given a higher priority over packets that are not as time sensitive. Once a higher priority packet reaches a network switch or router, the router would schedule the higher priority packet to be sent out ahead of the lower priority packets to minimize the amount of delay for the high priority packet. The drawback to prioritizing packets to minimize delay is that network switches and routers must be equipped to recognize the priority. Currently, not every network is set up to employ this scheme. Furthermore, a network passing a prioritized packet to another network must recognize the prioritizing scheme used by the first network, otherwise the prioritization of the packet is lost. Moreover, since prioritization only minimizes delay and does guarantee a minimum delay, a highly congested network employing a prioritization scheme may still have a delay too high to employ reliable voice conversations.

A further way to manage bandwidth of Internet telephony on a packet-switched network is to regulate the amount of bandwidth used for a voice conversation. The bandwidth of a voice conversation can be limited by using a particular method to encode the voice conversation or codec that minimizes bandwidth usage. Typically, codecs balance the amount of bandwidth used for the voice conversation versus the quality of the voice encoded. Thus, the lower the bandwidth usually the lower the voice quality. Therefore, the user of the Internet telephone or the user of the network could determine the proper codec to use at the time the call is set up to properly balance the quality of the voice conversation based on a prediction of the bandwidth need of the system. Because the codec chosen at the beginning of the call cannot be changed during the call responsive to actual conditions in the network, bandwidth allocation of the Internet telephone is static. In other words, on current VoIP networks, once the call is set up the codec cannot be changed when conditions on the network change.

### SUMMARY

A system and method to manage Internet telephony bandwidth including a network switch to collect network information, and a telephone switch coupled with a network switch to dynamically allocate bandwidth of an Internet telephone based on network information received from a network switch are described herein.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an embodiment of an Internet telephony system with bandwidth management;

FIG. 2 illustrates an embodiment of an Internet telephony system with bandwidth management;

FIG. 3 illustrates an embodiment of an Internet telephony system with bandwidth management;

FIG. 4 illustrates an embodiment of an Internet telephony system with bandwidth management using a Virtual Local Area Network;

FIG. 5 illustrates a decision flow diagram implemented in an embodiment of an Internet telephony system with bandwidth management;

FIG. 6 illustrates a decision flow diagram implemented in an embodiment of an Internet telephony system with bandwidth management; and

FIG. 7 illustrates a decision flow diagram implemented in an embodiment of an Internet telephony system with bandwidth management.

### DETAILED DESCRIPTION

Embodiments of a system are described to provide bandwidth management for Internet telephony on a packet-switched network are described as well as methods for implementing bandwidth management for Internet telephony. In particular, a system is described to employ bandwidth management for a Voice over Internet Protocol telephone on a packet-switched network. The system includes equipment that monitors the network use and communicates with an Internet telephone in use on the system to adjust the bandwidth usage of the phones dynamically as conditions on the network change. Thus, the bandwidth used by an Internet telephone may be adjusted during the phone call to minimize the bandwidth of the Internet telephone to avoid congestion on the network. Moreover, the system may increase the bandwidth that is used by an Internet telephone, for example to provide better voice quality or quality of service, if extra bandwidth is available on the network. Therefore, the network needs between voice and data may be managed dynamically based on real-time network information.

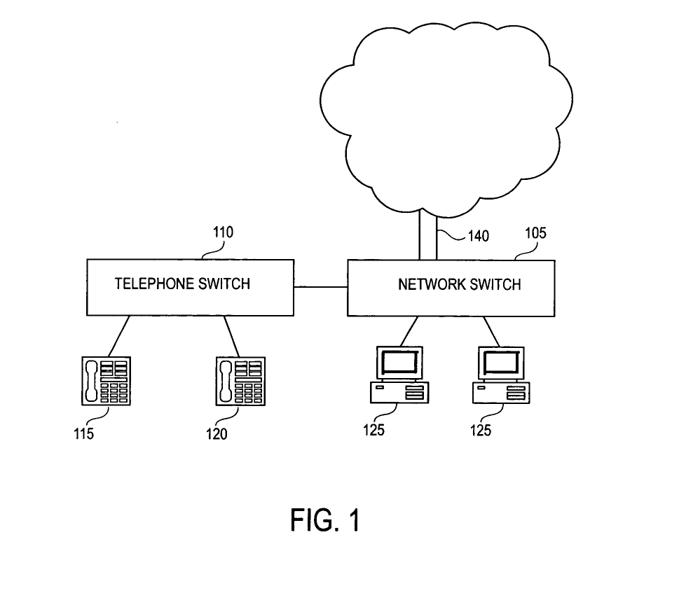

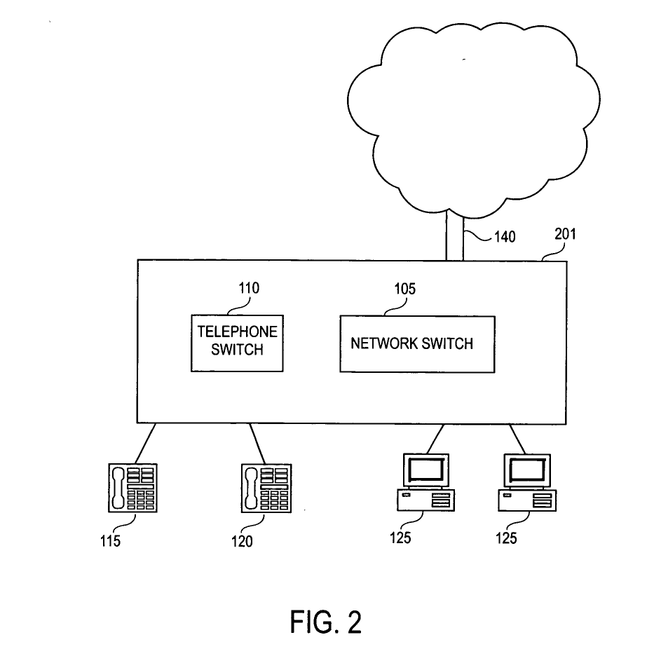

FIG. 1 illustrates an embodiment of a system according to the present invention. In the FIG. 1 embodiment, Internet telephones 115, 120 are connected to a packet-switched network through a telephone switch 110. For an embodiment the telephone switch 110 is a private branch exchange (PBX). For some embodiments, the telephone switch 110 is implemented in software. Other network devices such as computers 125 may be connected to a network switch 105. In an embodiment as illustrated in FIG. 2, the telephone switch 110 and the network switch 105 are collocated in a single network element 201. One collocated embodiment includes a network switch 105 and a telephone switch 110 implemented in the same physical computer.

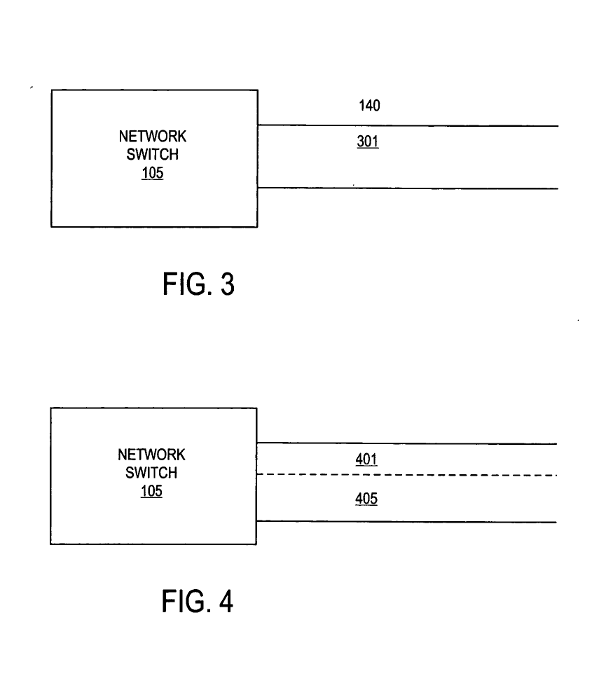

For an embodiment, Internet telephones 115, 120 and computers 125 are connected to a packet-switch network such as the Internet through the network switch 110 through an Internet connection 140. Internet connection 140 may be a T1, Digital Subscriber Line (DSL), or Cable connection to a packet-switched network. In an embodiment, all the bandwidth 301 of Internet connection 140 is available for both data and Internet telephony as illustrated in FIG. 3. For another embodiment, the network switch may allocate some bandwidth of Internet connection 140 only for data and some bandwidth only for Internet telephony. Furthermore, an embodiment of a network switch 110 may reallocate the amount of bandwidth reserved for data and Internet telephony as conditions on the network change. For example, a T1 Internet connection carries twenty-four Digital Signal 0 (DS0) channels. Each one of these channels may be assigned to carry just data or just Internet telephony. For an embodiment connected to a T1 Internet connection, a network switch 110 may dynamically reallocate the use of a DS0 channel to carry data or Internet telephony if the needs of the network require more bandwidth for data or Internet telephony.

Network switch 105 monitors the performance of the packet-switched network. Specifically, the network switch 105 may monitor resources used on the network including bandwidth usage, number of active sessions, number of phone conversations, and other aspects that affect network performance. The information monitored by the network switch 105 may be sent to the telephone switch 110, so the telephone switch 110 may determine how to adjust the bandwidth of an Internet telephone 115, 120 in use on the network. In an alternative embodiment, the network switch 110 may send the telephone switch 110 a command to adjust the bandwidth of an Internet telephone 115, 120 in use on the network responsive to activity on the network. Yet another embodiment includes a telephone switch 110 that retrieves the network performance information from the network switch 105. Once the information is retrieved from the network switch 105, the telephone switch 110 uses the information to determine how to adjust the bandwidth of an Internet telephone 115, 120 on the network.

An embodiment includes a telephone switch 110 that directs the network switch 105 to minimize the use of data bandwidth through the network switch 105 to provide more bandwidth for internet telephony. For an embodiment, the telephone switch 110 may direct the network switch 105 to restrict or limit bandwidth use for data based on the need for the telephone switch 110 to provide bandwidth for an Internet telephone 115, 120 designated as high priority. For one embodiment, the network switch 105 may minimize data bandwidth by refusing to accept data traffic from data devices such as computers 125. If the network switch 105 determines that data bandwidth cannot be reduced, an embodiment of a network switch 105 will inform a telephone switch 110 that the data bandwidth cannot be reduced. An embodiment of a telephone switch 110 may then refuse to allow any Internet telephones 115, 120 access to the network. For an embodiment, the user of an Internet telephone 115, 120 would hear a voice recording indicating all circuits are busy and to try the call at a later time.

For an embodiment, the communication between a network switch 105 and a telephone switch 110 may be established in overhead bytes of a communication stream. Another embodiment includes communication established between a network switch 105 and a telephone switch 110 through a dedicated channel. Yet another embodiment includes the network switch 105 and a telephone switch 110 communicating through packets.

To adjust the bandwidth of the Internet phone the telephone switch 110 may negotiate with an Internet phone 115, 120 in use on the network to use a different codec. In such an embodiment, the telephone switch 110 may negotiated the use of a codec that requires less bandwidth if the network requires more bandwidth. Conversely, the telephone switch 110 may negotiate the use of a codec that requires more bandwidth to improve voice quality if the network has spare bandwidth. Moreover, an embodiment may negotiate with an Internet telephone 115, 120 to use a codec more tolerant of packet jitter or packet loss to improve quality of service. One embodiment may drop Internet telephone conversations if using a different codec is not possible or would not increase network performance. The telephone switch 110 may handle any number of codecs including standardized codecs such as a Global System for Mobile communications codec (GSM), G.711, G.729, G.723.1, G.722, and G.728. Moreover, the telephone switch 110 may handle non-standardized codecs or proprietary codecs. Because some codecs require licenses, an embodiment of a telephone switch 110 may monitor the use of a licensed codec and negotiate the use of another codec if the maximum number of a licensed codec in use is reached or exceeded.

FIG. 4 illustrates an embodiment where the connection 140 is segmented into a Virtual Local Area Network (VLAN) to provide a fixed amount of bandwidth for Internet telephony 401 leaving the rest of the bandwidth for data 405. In an embodiment, an Internet telephone 115, 120 when first connected to the network is assigned to a VLAN designated for voice traffic. In a VLAN embodiment, the network switch 105, monitoring the network performance, may determine a current call load exceeds the bandwidth allocated for phone calls. The network switch 105 may then request more bandwidth from the telephone switch 110. To reduce the amount of bandwidth used for telephone calls, the telephone switch 110 may negotiate with an Internet telephone 115, 120 to use a lower bandwidth codec.

Embodiments of the telephone switch 110 may use VoIP control protocols such as Session Initiation Protocol (SIP), Inter-Asterisk exchange (IAX), H.323, Media Gateway Control (MEGACO), and Telecommunications and Internet Protocol Harmonization over Networks (TIPHON) to negotiate the use of a new codec with an Internet telephone 115, 120. For an embodiment, a telephone switch 110 may use a priority scheme to determine which Internet telephone 115, 120 to dynamically manage. For example, Internet telephone 115 may have a guaranteed bandwidth but Internet telephone 120 may not. In such a circumstance that Internet telephone 115 is already operating at a bandwidth guaranteed by the network, an embodiment of a telephone switch 110 would only negotiate with Internet telephone 120 to use a codec requiring less bandwidth. If the Internet telephone 120 is already operating at the lowest bandwidth available, the telephone switch 110 may disconnect the Internet telephone 120 from the network. For an embodiment, the phone conversation on Internet telephone 120 may be interrupted by a message indicating the call will be disconnected and to try the call later.

An embodiment of a packet-switched network according to the present invention Internet telephones 115, 120 may support video as well as audio. For an embodiment the telephone switch 110 may reduce the quality of the video to reduce bandwidth usage or suspend the video portion of the stream when the network switch 105 indicates more bandwidth is needed on the network. Moreover, the system may also negotiate a different codec for the audio portion.

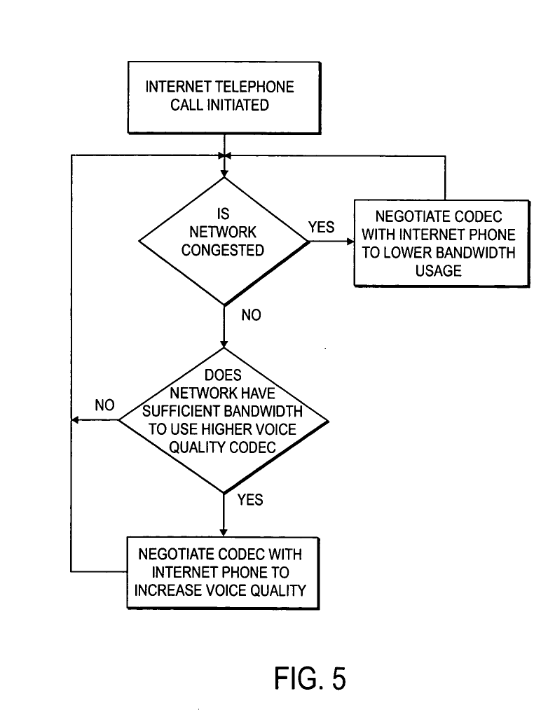

The criteria used to manage the bandwidth of Internet telephony on a packet-based network may be based solely on the need for bandwidth or can be more complex and consider many variables. For example and not limitation, FIGS. 5-7 illustrate criterion that may be used in embodiments to manage the bandwidth of Internet telephony on a packet based network. FIG. 5 illustrates an exemplary decision flow diagram used in an embodiment where a criterion for managing bandwidth is based on whether the network at the given time is congested. In the FIG. 5 embodiment, if there is network congestion the system will negotiate with Internet telephones 115, 120 in use on the network to use a codec requiring less network resources such as bandwidth. Moreover, an embodiment such as the FIG. 5 embodiment may negotiate with the Internet phones 115, 120 in use on the network to increase bandwidth use, for example to increase voice quality.

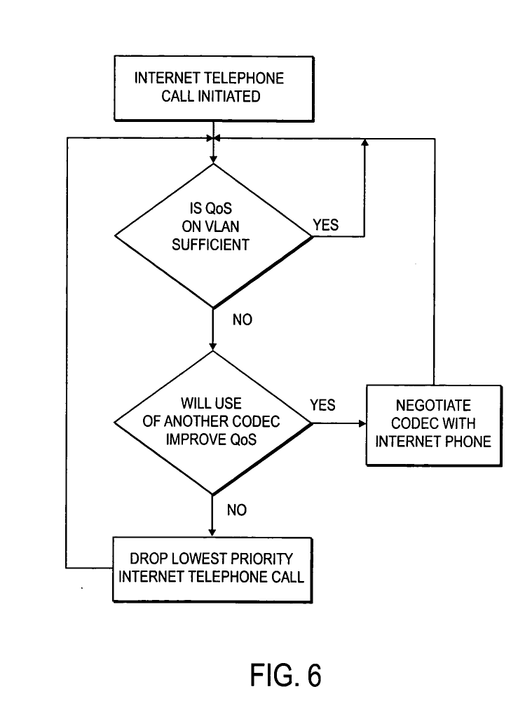

FIG. 6 illustrates another embodiment of criteria that may be used in a system to manage bandwidth of a network having Internet telephones 115, 120. In the FIG. 6 embodiment, the system assigns Internet telephones 115, 120 to a VLAN. The FIG. 6 embodiment monitors the quality of service of the Internet telephone call. The quality of service can include the number of dropped voice packets, the delay between voice packets, and the number of dropped calls. If the quality of service is not sufficient on an Internet telephone call the system may negotiate the use of another codec with the Internet telephones 115, 120 in use on the network. In an embodiment, if negotiating the use of another codec with the Internet telephone 115, 120 will not improve the quality of service, the system may drop an Internet telephone call. One embodiment includes dropping the Internet telephone call assigned the lowest call priority. The call priority may be assigned by a network administrator, determined by the price paid for the service, determined by the order in which the calls where made, or a combination of these and other criteria. Embodiments that negotiate with Internet telephones 115, 120 to improve the quality of service are not limited to the VLAN embodiments.

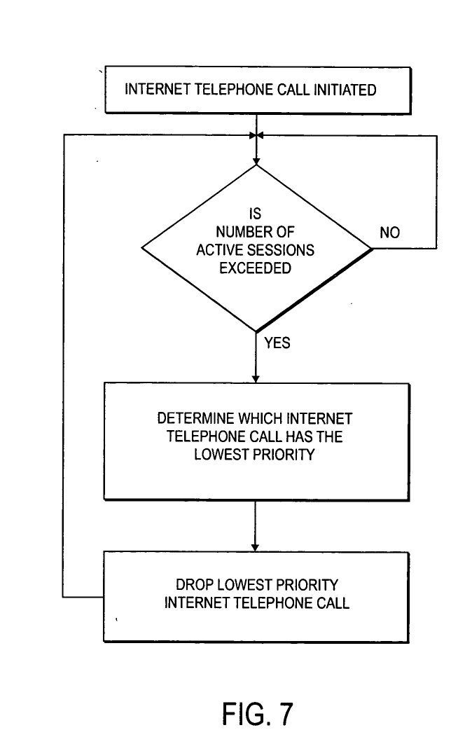

Another embodiment may use criteria as illustrated in the FIG. 7 decision flow diagram to manage bandwidth. In the FIG. 7 embodiment, the system monitors network congestion by restricting the number of Internet telephone and data active sessions on a network. If the number of active sessions is exceeded, the system may restrict new Internet telephone calls on the network. In another embodiment, the system may determine if the new Internet telephone call has priority over another Internet telephone call on the network. The system may then terminate the lower priority call or negotiate the use of a different codec to avoid network congestion.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system to manage Internet telephony bandwidth comprising:
a network switch to collect network information; and
a telephone switch coupled with said network switch to dynamically allocate bandwidth for an Internet telephone based on said network information received from said network switch.

2. The system to manage Internet telephony bandwidth of claim 1, wherein said telephone switch is a private branch exchange.

3. The system to manage Internet telephony bandwidth of claim 1, wherein said telephone switch dynamically allocates bandwidth for said Internet telephone through the use of a new codec between said telephone switch and said Internet telephone.

4. The system to manage Internet telephony bandwidth of claim 1, wherein said telephone switch dynamically allocates bandwidth by directing the network switch to restrict data bandwidth.

5. The system to manage Internet telephony bandwidth of claim 2, wherein said telephone switch is implemented in software.

6. The system to manage Internet telephony bandwidth of claim 2, wherein said telephone switch and said network switch are embodied in one network element.

7. The system to manage Internet telephony bandwidth of claim 3, wherein said telephone switch dynamically allocates bandwidth for said Internet telephone to improve quality of service.

8. An network element comprising:
a network switch to monitor network performance;
a private branch exchange coupled with said switch to manage bandwidth for a Voice over Internet Protocol telephone based on said network performance.

9. The network element of claim 8, wherein said private branch exchange is implemented in software.

10. The network element of claim 8, wherein said private branch exchange manages bandwidth for said Voice over Internet Protocol telephone based on network performance retrieved from said network switch.

11. The network element of claim 8, wherein said private branch exchange manages network bandwidth based on network performance indicated by one or more criterion selected from a group consisting of bandwidth load, number of active sessions on the network, number of phone conversations on the network, historical bandwidth information of a network, and quality of service.

12. The network element of claim 8, wherein said private branch exchange manages network bandwidth based on network performance through the use of a lower bandwidth codec between said private branch exchange and said Voice over Internet protocol phone.

13. The network element of claim 9, wherein said private branch exchange manages network bandwidth for said Voice over Internet Protocol telephone by directing said network switch to reduce data bandwidth.

14. The network element of claim 10, wherein said private branch exchange manages bandwidth for said Voice over Internet Protocol telephone responsive to a command sent by said switch based on network performance.

15. A method comprising:
monitoring conditions of a packet-switched network; and
dynamically allocating bandwidth for an Internet telephone in use on said packet-switched network responsive to conditions of said packet-switched network.

16. The method of claim 15, wherein dynamically allocating bandwidth is performed by a telephone switch.

17. The method of claim 15, wherein dynamically allocating bandwidth for said Internet telephone is responsive to a need for bandwidth on said packet-switched network.

18. The method of claim 15, wherein dynamically allocating bandwidth for an Internet telephone includes negotiating the use of a codec with said Internet telephone.

19. The method of claim 15, wherein dynamically allocating bandwidth for an Internet telephone includes limiting data bandwidth on said packet-switched network.

20. The method of claim 16, wherein said telephone switch is a private branch exchange.
